(19) United States
(12) Patent Application Publication
(10) Pub. No.: US 2026/0228559 A1
(43) Pub. Date: Aug. 6, 2026

(54) NON-TRANSITORY COMPUTER-READABLE RECORDING MEDIUM, TRAINING METHOD, INFERENCE METHOD, AND INFORMATION PROCESSING APPARATUS

(71) Applicant: Fujitsu Limited, Kawasaki-shi, Kanagawa (JP)

(72) Inventor: Kanata SUZUKI, Kawasaki (JP)

(73) Assignee: Fujitsu Limited, Kawasaki-shi, Kanagawa (JP)

(21) Appl. No.: 19/464,714

(22) Filed: Jan. 30, 2026

(30) Foreign Application Priority Data
Feb. 4, 2025 (JP) 2025-017005

(51) Int. Cl. G06N 3/098; B25J 9/16; G06N 3/0985

(52) U.S. Cl. CPC G06N 3/098; B25J 9/163; B25J 9/1664; G06N 3/0985

(57) ABSTRACT

A non-transitory computer-readable recording medium has stored therein a program that causes a computer to execute a process including adding a shared parameter to parameters of a plurality of motion learning models that each predict a second state of a target from a first state of the target and a parameter of a language learning model that has been trained, the language learning model being related to a motion instruction for the target obtaining a training data set including a plurality of sets of training data each having the first state as input data and the second state as ground truth data and optimizing the shared parameter and a parameter of a motion learning model of the plurality of motion learning models, the motion learning model corresponding to the training data set, in a state where the parameter of the language learning model has been fixed.

### CROSS-REFERENCE TO RELATED APPLICATION

This application is based upon and claims the benefit of priority of the prior Japanese Patent Application No. 2025-017005, filed on February 4, 2025, the entire contents of which are incorporated herein by reference.

### FIELD

The embodiment discussed herein is related to a training program.

### BACKGROUND

In the field of robotics, attempts have been made to construct a foundation model (hereinafter referred to as the robot foundation model), which is designed to adapt to various tasks and environments. For example, in construction and deployment of robot foundation models, machine learning models centered on deep learning are utilized.

One approach to constructing a robot foundation model is imitation learning. Imitation learning is

learning in which motion experiences themselves are generalized by self-supervised learning of motions themselves taught to a robot by humans.

Furthermore, conventional techniques related to continual learning for robot foundation models include, for example: a technique of fine tuning involving regularization of model weights; a technique of reproducing data used in past learning; and a technique of dividing model weights.

For example, in the technique of fine tuning involving regularization of model weights, learning is performed while applying regularization so as to preserve weight parameters having important information for previous tasks. In the technique of replaying data used in past learning, a generator for replaying training data used in past tasks is prepared and subsequent tasks inherit the generator in combination with a solver that solves results generated by the generator. In the technique of replaying data used in past learning, the number of neurons used in a model is limited and one network is divided into multiple parts to handle multiple tasks.

Patent Literature 1: Japanese Laid-open Patent Publication No. 2023-018893

Patent Literature 2: Japanese Laid-open Patent Publication No. 2021-192141

Patent Literature 3: Japanese Laid-open Patent Publication No. 2010-020446

Patent Literature 4: U.S. Patent Application Publication No. 2023/0109398

Patent Literature 5: U.S. Patent Application Publication No. 2022/0147876

### SUMMARY

According to an aspect of an embodiment, a non-transitory computer-readable recording medium has stored therein a program that causes a computer to execute a process including adding a shared parameter to parameters of a plurality of motion learning models that each predict a second state of a target from a first state of the target and a parameter of a language learning model that has been trained, the language learning model being related to a motion instruction for the target obtaining a training data set including a plurality of sets of training data each having the first state as input data and the second state as ground truth data and optimizing, by using the training data set, the shared parameter and a parameter of a motion learning model of the plurality of motion learning models, the motion learning model corresponding to the training data set, in a state where the parameter of the language learning model has been fixed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a first diagram for description of a process in a training phase, according to an embodiment;

FIG. 2 is a second diagram for description of the process in the training phase, according to the embodiment;

FIG. 3 is a diagram illustrating an example of a data structure of a training result table;

FIG. 4 is a first diagram for description of a process in an inference phase, according to the embodiment;

FIG. 5 is a second diagram for description of the process in the inference phase, according to the embodiment;

FIG. 6 is a third diagram for description of the process in the inference phase, according to the embodiment;

FIG. 7 is a diagram illustrating a system according to

the embodiment;

FIG. 8 is a functional block diagram illustrating a configuration of an information processing apparatus according to the embodiment;

FIG. 9 is a flowchart illustrating a procedure for a process in a training phase by the information processing apparatus according to the embodiment;

FIG. 10 is a flowchart illustrating a procedure for a process in an inference phase by the information processing apparatus according to the embodiment; and

FIG. 11 is a diagram illustrating an example of a hardware configuration of a computer that implements functions similar to those of the information processing apparatus according to the embodiment.

### DESCRIPTION OF EMBODIMENT

However, the above mentioned conventional techniques have a problem in that reducing the computational cost while minimizing degradation of the prediction performance of the machine learning models is difficult with these techniques.

For example, in the technique of fine tuning involving regularization of model weights, fine tuning may impair performance of previous tasks. In the technique of replaying data used in past learning, performance of previous tasks may be impaired according to the precision of replay of past data. In the technique of dividing model weights, the precision is limited because model weights are divided.

Furthermore, for robot foundation models, in a case where the machine learning model or the data scale is large and performance is continuously added, the computational cost increases.

Preferred embodiments of the present invention will be explained with reference to accompanying drawings. The invention is not to be limited by this embodiment.

An information processing apparatus according to an embodiment executes a process in an inference phase after executing a process in a training phase. The information processing apparatus according to the embodiment will be referred to as the "information processing apparatus 100".

For example, through the process in the training phase, the information processing apparatus 100 stores optimal values of a shared parameter added to motion learning models and a language learning model and optimal values of parameters of the motion learning models. In the inference phase, the information processing apparatus 100 uses data obtained from a robot in a real environment to perform lightweight optimization of the shared parameter, which has been initialized, generates a reference parameter that has been optimized, selects an optimal motion learning model on the basis of each shared parameter in the training phase and the reference parameter, and utilizes the optimal motion learning model in inference. Reduction in the prediction performance of the machine learning model is thereby able to be minimized and the computational cost of the machine learning model is able to be reduced. The process in the training phase and the process in the inference phase will hereinafter be described more specifically.

### Process in Training Phase

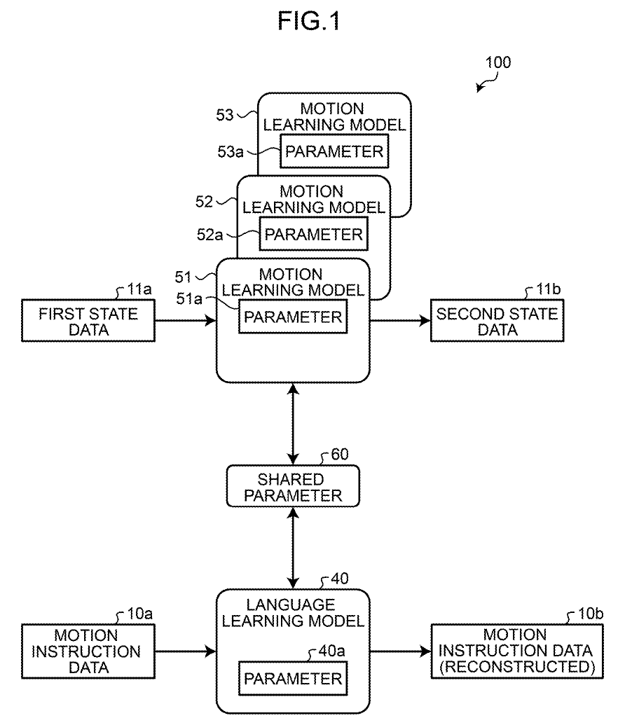

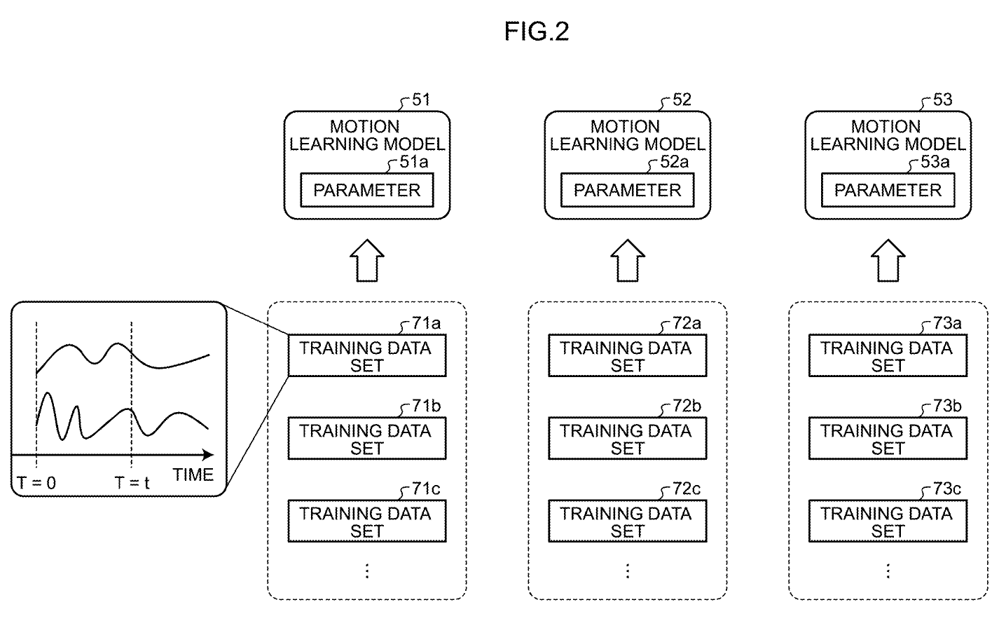

An example of the process in the training phase by the information processing apparatus 100 will be described first. FIG. 1 and FIG. 2 are diagrams for description of the process in the training phase, according to the embodiment. FIG. 1 will be described first. The information processing apparatus 100 has a language learning model 40 and motion learning models 51, 52, and 53.

The language learning model 40 is, for example, a large language model (LLM). The language learning model 40 is assumed to be a model that has been trained, and a parameter 40a of the language learning model 40 is assumed to have been optimized.

The motion learning models 51, 52, and 53 are, for example, machine learning models, such as long short-term memories (LSTMs). This embodiment will be described using the motion learning models 51, 52, and 53, but another motion learning model may be included further.

The motion learning model 51 is a model that predicts motion of a robot that performs a first task. The first task is a task of folding clothes, for example. The motion learning model 51 has a parameter 51a.

The motion learning model 52 is a model that predicts motion of the robot that performs a second task. The second task is a task of tying a string, for example. The motion learning model 52 has a parameter 52a.

The motion learning model 53 is a model that predicts motion of the robot that performs a third task. The third task is a task of moving clothes, for example. The motion learning model 53 has a parameter 53a.

The information processing apparatus 100 sets a shared parameter 60 in an intermediate layer of the language learning model 40. The information processing apparatus 100 sets the shared parameter 60 in intermediate layers of the motion learning models 51 to 53. The shared parameter 60 is a low-dimensional parameter. For example, a low dimension is a dimension included in the fifth dimension to the tenth dimension and may be modified as appropriate.

The language learning model 40 is trained through the training phase to output motion instruction data 10b upon receipt of input of motion instruction data 10a, the motion instruction data 10b resulting from reconstruction of the motion instruction data 10a on the basis of the parameter 40a and the shared parameter 60. The parameter 40a is fixed and the shared parameter 60 is optimized. The motion instruction data 10a are text data, such as, for example, "Please fold the clothes", "Please tie the string", or "Please move the clothes".

The motion learning model 51 is trained through the training phase to output second state data 11b upon receipt of input of first state data 11a, on the basis of the parameter 51a and the shared parameter 60. The first state data 11a include joint angles of the robot and image data of the robot, at a time T = t. The second state data 11b are data of joint angles of the robot and image data of the robot, at a time T = t + α. The image data of the robot may be image data from a camera installed in the robot or image data having the appearance of the robot captured therein.

The motion learning model 52 is trained through the training phase to output second state data 11b upon receipt of input of first state data 11a, on the basis of the parameter 52a and the shared parameter 60.

The motion learning model 53 is trained through the training phase to output second state data 11b upon receipt of input of first state data 11a, on the basis of the parameter 53a and the shared parameter 60.

FIG. 2 will be described next. The information processing apparatus 100 has training data sets 71a, 71b, 71c, 72a, 72b, 72c, 73a, 73b, and 73c. The training data sets 71a to 71c are data for training the motion learning model 51. For example, the training data sets 71a to 71c are time-series data of joint angles of the robot that executes the first task and time-series image data of the robot.

The training data sets 72a to 72c are data for training the motion learning model 52. For example, the training data sets 72a to 72c are time-series data of joint angles of the robot that executes the second task and time-series image data of the robot.

The training data sets 73ato 73c are data for training the motion learning model 53. For example, the training data sets 73a to 73c are time-series data of joint angles of the robot that executes the third task and time-series image data of the robot.

An example of a process in which the information processing apparatus 100 trains the motion learning model 51 and the language learning model 40 by using the training data set 71a will be described now. Firstly, the information processing apparatus 100 sets the shared parameter 60 to its initial value.

The information processing apparatus 100 repeatedly executes processing of inputting motion instruction data 10a (for example, "Please fold the clothes") prepared beforehand to the language learning model 40, obtaining motion instruction data 10b, and optimizing the shared parameter 60, so that an error between the motion instruction data 10a and the motion instruction data 10b is minimized. The parameter 40a of the language learning model 40 is fixed.

The information processing apparatus 100 obtains input data including joint angles of the robot and image data of the robot at a time T = t, from the training data set 71a. Furthermore, the information processing apparatus 100 obtains ground truth data including joint angles of the robot and image data of the robot at a time T = t + α, from the training data set 71a. The information processing apparatus 100 repeatedly executes processing of optimizing the shared parameter 60 and the parameter 51a by error backpropagation so that an error between output upon input of the input data to the motion learning model 51 and the ground truth data is minimized.

The information processing apparatus 100 may alternately perform the training of the language learning model 40 and the training of the motion learning model 51 or may perform the training of one of the language learning model 40 and the motion learning model 51 after the training of the other one of the language learning model 40 and the motion learning model 51 is ended. When the training using the training data set 71a is ended, the information processing apparatus 100 registers the shared parameter 60 and the parameter 51a at the end of the training, into a training result table.

An example of a process in which the information processing apparatus 100 trains the motion learning model 51 and the language learning model 40 by using the training data set 71b will be described next. Firstly, the information processing apparatus 100 sets the shared parameter 60 to its initial value. The process in which the information processing apparatus 100 trains the motion learning model 51 and the language learning model 40 by using the training data set 71b is similar to the process in which the information processing apparatus 100 trains the motion learning model 51 and the language learning model 40 by using the training data set 71a. When the training using the training data set 71b is ended, the information processing apparatus 100 registers the shared parameter 60 and the parameter 51a at the end of the training, into the training result table.

An example of a process in which the information processing apparatus 100 trains the motion learning model 51 and the language learning model 40 by using the training data set 71c will be described next. Firstly, the information processing apparatus 100 sets the shared parameter 60 to its initial value. The process in which the information processing apparatus 100 trains the motion learning model 51 and the language learning model 40 by using the training data set 71c is similar to the process in which the information processing apparatus 100 trains the motion learning model 51 and the language learning model 40 by using the training data set 71a. When the training using the training data set 71c is ended, the information processing apparatus 100 registers the shared parameter 60 and the parameter 51a at the end of the training, into the training result table.

According to the above description, the information processing apparatus 100 sets the shared parameter 60 to its initial value upon the training using the training data sets 71b and 71c, but this processing is just an example, and training may be performed by inheriting the shared parameter 60 optimized in previous training.

An example of a process in which the information processing apparatus 100 trains the motion learning model 52 and the language learning model 40 by using the training data set 72a will be described next. Firstly, the information processing apparatus 100 sets the shared parameter 60 to its initial value.

The information processing apparatus 100 repeatedly executes processing of inputting motion instruction data 10a (for example, "Please tie the string") prepared beforehand to the language learning model 40, obtaining motion instruction data 10b, and optimizing the shared parameter 60 so that an error between the motion instruction data 10a and the motion instruction data 10b is minimized. The parameter 40a of the language learning model 40 is fixed.

The information processing apparatus 100 obtains input data including joint angles of the robot and image data of the robot at a time T = t, from the training data set 72a. Furthermore, the information processing apparatus 100 obtains ground truth data including joint angles of the robot and image data of the robot at a time T = t + α, from the training data set 72a. The information processing apparatus 100 repeatedly executes processing of optimizing the shared parameter 60 and the parameter 52a by error backpropagation so that an error between output upon input of the input data to the motion learning model 52 and the ground truth data is minimized.

The information processing apparatus 100 may alternately perform the training of the language learning model 40 and the training of the motion learning model 52 or may perform the training of one of the language learning model 40 and the motion learning model 52 after the training of the other one of the language learning model 40 and the motion learning model 52 is ended. When the training using the training data set 72a is ended, the information processing apparatus 100 registers the shared parameter 60 and the parameter 52a at the end of the training, into the training result table.

An example of a process in which the information processing apparatus 100 trains the motion learning model 52 and the language learning model 40 by using the training data set 72b will be described next. Firstly, the information processing apparatus 100 sets the shared parameter 60 to its initial value. The process in which the information processing apparatus 100 trains the motion learning model 52 and the language learning model 40 by using the training data set 72b is similar to the process in which the information processing apparatus 100 trains the motion learning model 52 and the language learning model 40 by using the training data set 72a. When the training using the training data set 72b is ended, the information processing apparatus 100 registers the shared parameter 60 and the parameter 52a at the end of the training, into the training result table.

An example of a process in which the information processing apparatus 100 trains the motion learning model 52 and the language learning model 40 by using the training data set 72c will be described next. Firstly, the information processing apparatus 100 sets the shared parameter 60 to its initial value. The process in which the information processing apparatus 100 trains the motion learning model 52 and the language learning model 40 by using the training data set 72c is similar to the process in which the information processing apparatus 100 trains the motion learning model 52 and the language learning model 40 by using the training data set 72a. When the training using the training data set 72c is ended, the information processing apparatus 100 registers the shared parameter 60 and the parameter 52a at the end of the training, into the training result table.

According to the above description, the information processing apparatus 100 sets the shared parameter 60 to its initial value upon the training using the training data sets 72b and 72c, but this processing is just an example, and training may be performed by inheriting the shared parameter 60 optimized in previous training.

An example of a process in which the information processing apparatus 100 trains the motion learning model 53 and the language learning model 40 by using the training data set 73a will be described now. Firstly, the information processing apparatus 100 sets the shared parameter 60 to its initial value.

The information processing apparatus 100 repeatedly executes processing of inputting motion instruction data 10a (for example, "Please move the clothes") prepared beforehand to the language learning model 40, obtaining motion instruction data 10b, and optimizing the shared parameter 60, so that an error between the motion instruction data 10a and the motion instruction data 10b is minimized. The parameter 40a of the language learning model 40 is fixed.

The information processing apparatus 100 obtains input data including joint angles of the robot and image data of the robot at a time T = t, from the training data set 73a. Furthermore, the information processing apparatus 100 obtains ground truth data including joint angles of the robot and image data of the robot at a time T = t + α, from the training data set 73a. The information processing apparatus 100 repeatedly executes processing of optimizing the shared parameter 60 and the parameter 53a by error backpropagation so that an error between output upon input of the input data to the motion learning model 53 and the ground truth data is minimized.

The information processing apparatus 100 may alternately perform the training of the language learning model 40 and the training of the motion learning model 53 or may perform the training of one of the language learning model 40 and the motion learning model 53 after the training of the other one of the language learning model 40 and the motion learning model 53 is ended. When the training using the training data set 73a is ended, the information processing apparatus 100 registers the shared parameter 60 and the parameter 53a at the end of the training, into the training result table.

An example of a process in which the information processing apparatus 100 trains the motion learning model 53 and the language learning model 40 by using the training data set 73b will be described next. Firstly, the information processing apparatus 100 sets the shared parameter 60 to its initial value. The process in which the information processing apparatus 100 trains the motion learning model 53 and the language learning model 40 by using the training data set 73b is similar to the process in which the information processing apparatus 100 trains the motion learning model 53 and the language learning model 40 by using the training data set 73a. When the training using the training data set 73b is ended, the information processing apparatus 100 registers the shared parameter 60 and the parameter 53a at the end of the training, into the training result table.

An example of a process in which the information processing apparatus 100 trains the motion learning model 53 and the language learning model 40 by using the training data set 73c will be described next. Firstly, the information processing apparatus 100 sets the shared parameter 60 to its initial value. The process in which the information processing apparatus 100 trains the motion learning model 53 and the language learning model 40 by using the training data set 73c is similar to the process in which the information processing apparatus 100 trains the motion learning model 53 and the language learning model 40 by using the training data set 73a. When the training using the training data set 73c is ended, the information processing apparatus 100 registers the shared parameter 60 and the parameter 53a at the end of the training, into the training result table.

According to the above description, the information processing apparatus 100 sets the shared parameter 60 to its initial value upon the training using the training data sets 73b and 73c, but this processing is just an example, and training may be performed by inheriting the shared parameter 60 optimized in previous training.

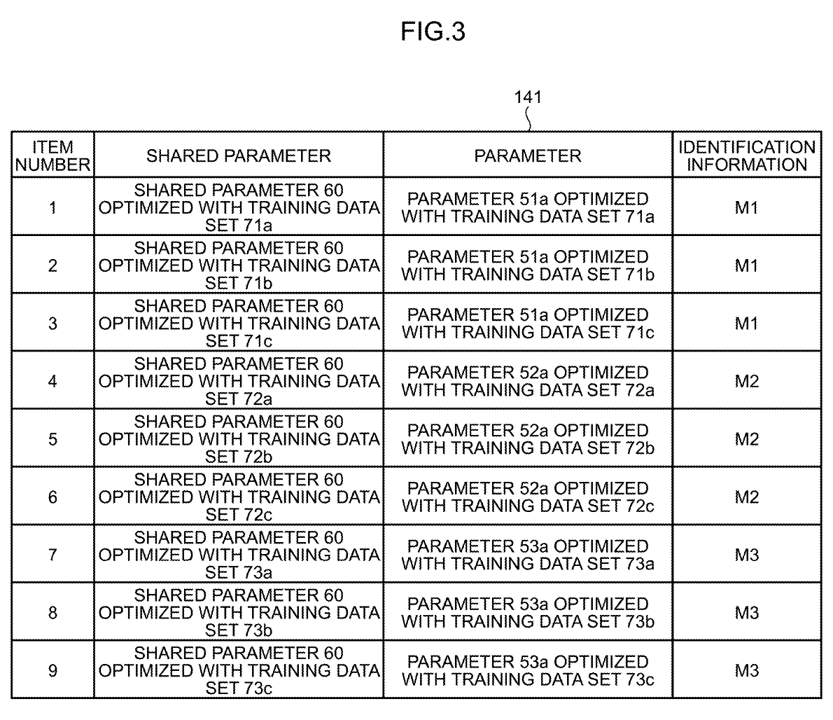

Information illustrated in FIG. 3 is registered in a training result table 141 by the information processing apparatus 100 executing the above described processing. FIG. 3 is a diagram illustrating an example of a data structure of a training result table. As illustrated in FIG. 3, the training result table 141 includes item numbers, shared parameters, parameters, and identification information. The item numbers are numbers that identify records. The identification information is information identifying motion learning models. For example, the identification information, "M1", represents the motion learning model 51. The identification information, "M2", represents the motion learning model 52. The identification information, "M3", represents the motion learning model 53.

The shared parameter of the item number, "1", in the training result table 141 is the shared parameter 60 optimized using the training data set 71a. The parameter of the item number, "1", in the training result table 141 is the parameter 51a of the motion learning model 51, the parameter 51a having been optimized using the training data set 71a.

The shared parameter of the item number, "2", in the training result table 141 is the shared parameter 60 optimized using the training data set 71b. The parameter of the item number, "2", in the training result table 141 is the parameter 51a of the motion learning model 51, the parameter 51a having been optimized using the training data set 71b.

The shared parameter of the item number, "3", in the training result table 141 is the shared parameter 60 optimized using the training data set 71c. The parameter of the item number, "3", in the training result table 141 is the parameter 51a of the motion learning model 51, the parameter 51a having been optimized using the training data set 71c.

The shared parameter of the item number, "4", in the training result table 141 is the shared parameter 60 optimized using the training data set 72a. The parameter of the item number, "4", in the training result table 141 is the parameter 52a of the motion learning model 52, the parameter 52a having been optimized using the training data set 72a.

The shared parameter of the item number, "5", in the training result table 141 is the shared parameter 60 optimized using the training data set 72b. The parameter of the item number, "5", in the training result table 141 is the parameter 52a of the motion learning model 52, the parameter 52a having been optimized using the training data set 72b.

The shared parameter of the item number, "6", in the training result table 141 is the shared parameter 60 optimized using the training data set 72c. The parameter of the item number, "6", in the training result table 141 is the parameter 52a of the motion learning model 52, the parameter 52a having been optimized using the training data set 72c.

The shared parameter of the item number, "7", in the training result table 141 is the shared parameter 60 optimized using the training data set 73a. The parameter of the item number, "7", in the training result table 141 is the parameter 53a of the motion learning model 53, the parameter 53a having been optimized using the training data set 73a.

The shared parameter of the item number, "8", in the training result table 141 is the shared parameter 60 optimized using the training data set 73b. The parameter of the item number, "8", in the training result table 141 is the parameter 53a of the motion learning model 53, the parameter 53a having been optimized using the training data set 73b.

The shared parameter of the item number, "9", in the training result table 141 is the shared parameter 60 optimized using the training data set 73c. The parameter of the item number, "9", in the training result table 141 is the parameter 53a of the motion learning model 53, the parameter 53a having been optimized using the training data set 73c.

As described above, the information processing apparatus 100 executes the process in the training phase, and the shared parameters optimized using the training data sets 71a to 73c and the parameters of the motion learning models 51 to 53 are thereby registered in the training result table 141. According to the above description, the motion instruction data 10a for the training using the training data sets 71a to 71c, 72a to 72c, and 73a to 73c are respectively different sets of text data. However, the same motion instruction data may be utilized for different tasks, and motion instruction data 10a for training using the training data sets 71a to 71c, 72a to 72c, and 73a to 73c may be a common set of text data.

### Process in Inference Phase

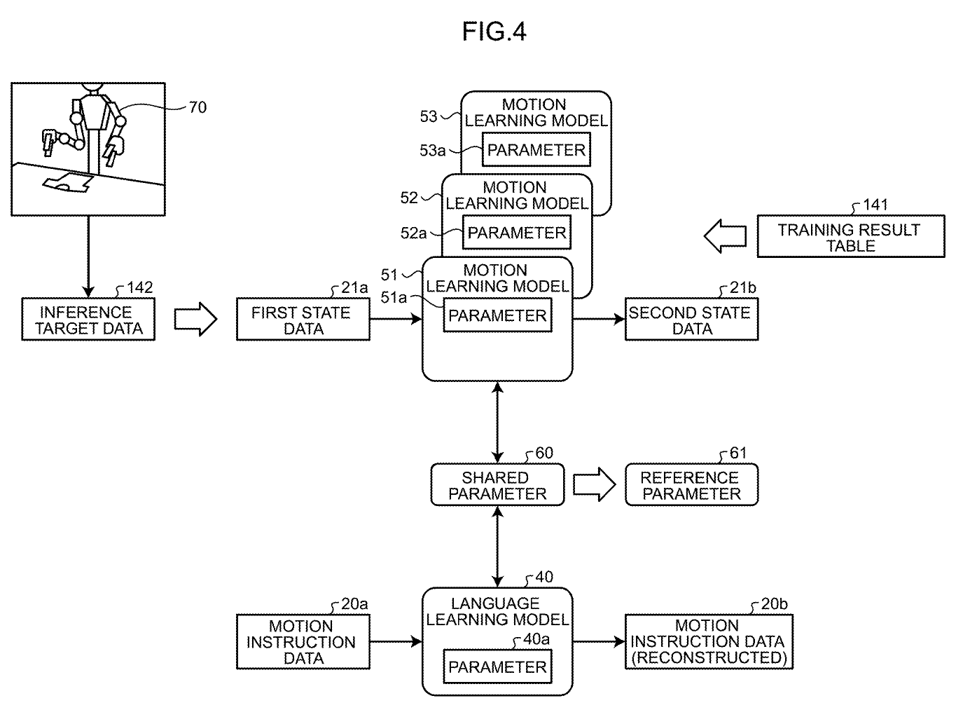

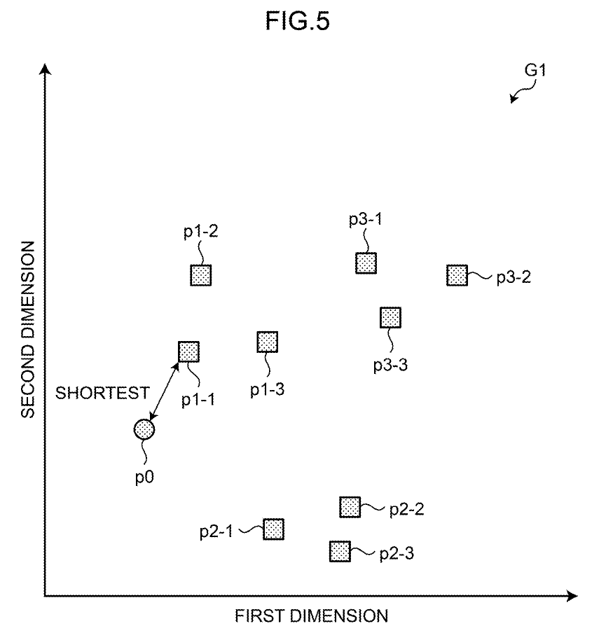

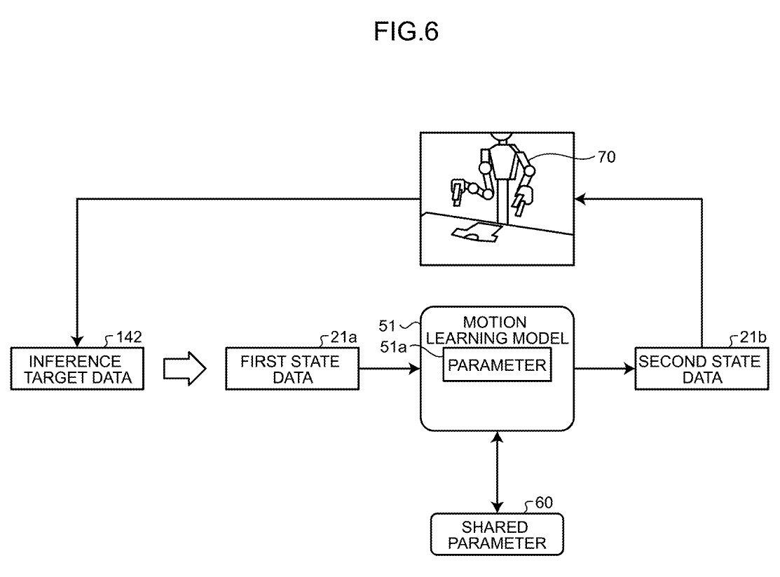

An example of the process in the inference phase by the information processing apparatus 100 will be described next. FIG. 4, FIG. 5, and FIG. 6 are diagrams for description of the process in the inference phase, according to the embodiment. FIG. 4 will be described first. On the basis of the training result table 141 generated in the training phase, the information processing apparatus 100 sets the parameters 51a to 53a of the motion learning models 51 to 53 and fixes the parameters 51a to 53a that have been set. Similarly to the parameter 40a set in the training phase, the parameter 40a of the language learning model 40 is fixed. The information processing apparatus 100 sets the shared parameter 60 to its initial value.

For example, the information processing apparatus 100 sets any one of the parameters of the item numbers 1 to 3 in the training result table 141, as the parameter 51a of the motion learning model 51. The information processing apparatus 100 may set the mean value of the parameters of the item numbers 1 to 3 in the training result table 141, as the parameter 51a of the motion learning model 51.

The information processing apparatus 100 sets any one of the parameters of the item numbers 4 to 6 in the training result table 141, as the parameter 52a of the motion learning model 52. The information processing apparatus 100 may set the mean value of the parameters of the item numbers 4 to 6 in the training result table 141, as the parameter 52a of the motion learning model 52.

The information processing apparatus 100 sets any one of the parameters of the item numbers 7 to 9 in the training result table 141, as the parameter 53a of the motion learning model 53. The information processing apparatus 100 may set the mean value of the parameters of the item numbers 7 to 9 in the training result table 141, as the parameter 53a of the motion learning model 53.

Subsequently, by executing light training using inference target data 142 obtained from a robot 70, the information processing apparatus 100 generates a reference parameter 61 resulting from optimization of the shared parameter 60. On the basis of the reference parameter 61 and the training result table 141, the information processing apparatus 100 selects a motion learning model suitable for performing inference on the inference target data 142, from the motion learning models 51 to 53.

The inference target data 142 include joint angles of the robot 70 in an inference target environment and image data of the robot 70. The joint angles of the robot 70 in the inference target environment are, for example, values actually measured by sensors installed at joints of the robot 70. The image data of the robot 70 may be image data from a camera installed in the robot 70 in the inference target environment or image data having the appearance of the robot 70 captured therein. The information processing apparatus 100 obtains motion instruction data 20a utilized in the inference target environment.

The light training performed by the information processing apparatus 100 using the inference target data 142 will hereinafter be described more specifically. The information processing apparatus 100 executes a process N times, the process including inputting the motion instruction data 20a to the language learning model 40, obtaining motion instruction data 20b, and optimizing the shared parameter 60, so that an error between the motion instruction data 20a and the motion instruction data 20b is minimized. The parameter 40a of the language learning model 40 is fixed. N is a natural number between 5 and 10 inclusive and may be modified as appropriate.

The information processing apparatus 100 obtains first state data 21a including joint angles of the robot and image data of the robot at a time T = t, from the inference target data 142. The information processing apparatus 100 obtains ground truth data including joint angles of the robot and image data of the robot at a time T = t + α, from the inference target data 142.

The information processing apparatus 100 executes processing of optimizing the shared parameter 60 N times so that an error between output (second state data 21b) upon input of input data to the motion learning model 51 and ground truth data is minimized.

The information processing apparatus 100 executes processing of optimizing the shared parameter 60 N times so that an error between output (second state data 21b) upon input of input data to the motion learning model 52 and ground truth data is minimized.

The information processing apparatus 100 executes processing of optimizing the shared parameter 60 N times so that an error between output (second state data 21b) upon input of input data to the motion learning model 53 and ground truth data is minimized.

By executing the above described processing, the information processing apparatus 100 obtains the reference parameter 61. The training of the language learning model 40 and the training of the motion learning models 51 to 53 may be alternately performed or the training of one of the language learning model 40 and the motion learning models 51 to 53 may be performed after the training of the other one of the language learning model 40 and the motion learning models 51 to 53 is ended.

FIG. 5 will be described next. The information processing apparatus 100 compares a distance between the reference parameter 61 and each of the shared parameters in the training result table 141 and selects a motion learning model corresponding to the shared parameter with the shortest distance.

The horizontal axis of a graph G1 in FIG. 5 is an axis corresponding to the first dimension and the vertical axis of the graph G1 is an axis corresponding to the second dimension. For convenience of description, FIG. 5 will be described with respect to two axes, but the embodiment is not limited to this example.

For example, a point p0 in the graph G1 corresponds to the reference parameter 61. A point p1-1 in the graph G1 corresponds to the shared parameter of the item number 1 in the training result table 141. A point p1-2 in the graph G1 corresponds to the shared parameter of the item number 2 in the training result table 141. A point p1-3 in the graph G1 corresponds to the shared parameter of the item number 3 in the training result table 141.

A point p2-1 in the graph G1 corresponds to the shared parameter of the item number 4 in the training result table 141. A point p2-2 in the graph G1 corresponds to the shared parameter of the item number 5 in the training result table 141. A point p2-3 in the graph G1 corresponds to the shared parameter of the item number 6 in the training result table 141.

A point p3-1 in the graph G1 corresponds to the shared parameter of the item number 7 in the training result table 141. A point p3-2 in the graph G1 corresponds to the shared parameter of the item number 8 in the training result table 141. A point p3-3 in the graph G1 corresponds to the shared parameter of the item number 9 in the training result table 141.

The information processing apparatus 100 calculates a distance between the point p0 and each of the other points p1-1 to p1-3,p2-1 to p2-3, and p3-1 to p3-3, and determines which one of the other points p1-1 to p1-3, p2-1 to p2-3, and p3-1 to p3-3 has the shortest distance. In the example illustrated in FIG. 5, the distance between the point p0 and the point p1-1 is the shortest. In this case, the information processing apparatus 100 selects the motion learning model 51 corresponding to the point p1-1 (the shared parameter of the item number 1). This is because the identification information corresponding to the shared parameter of the item number 1 described with respect to FIG. 5 is "M1 (motion learning model 51)", for example.

FIG. 6 will be described next. A case where the information processing apparatus 100 has selected the motion learning model 51 by the above described processing will now be described. The information processing apparatus 100 sets the shared parameter of the item number 1 in the training result table 141 as the shared parameter 60. Description related to the parameter 51a of the motion learning model 51 is similar to the description of the parameter 51a of the motion learning model 51 described with respect to FIG. 4.

The information processing apparatus 100 obtains the latest inference target data 142 from the robot 70 and obtains, as the first state data 21a, joint angles of the robot and image data of the robot at the latest time. By inputting the first state data 21a to the motion learning model 51, the information processing apparatus 100 obtains second state data 21b. The information processing apparatus 100 outputs the second state data 21b as a motion command, to the robot 70. The information processing apparatus 100 repeatedly executes the above described processing.

The processing executed by the information processing apparatus 100 in the inference phase has been described above. For example, as described above, in the inference phase, the information processing apparatus 100 adds the shared parameter 60 to the parameters 51a to 53a of the motion learning models 51 to 53 and the parameter 40a of the language learning model 40. The information processing apparatus 100 obtains inference target data from the robot 70, and generates the reference parameter 61 resulting from optimization of the shared parameter on the basis of the inference target data, in a state where the optimized parameters of the language learning model and motion learning models have been fixed. The information processing apparatus 100 selects a motion learning model from the motion learning models 51 to 53 on the basis of a plurality of shared parameters obtained from the motion learning models 51 to 53 through prior training and the reference parameter 61, and infers a second state by inputting a first state in the inference target data to the motion learning model selected.

### System

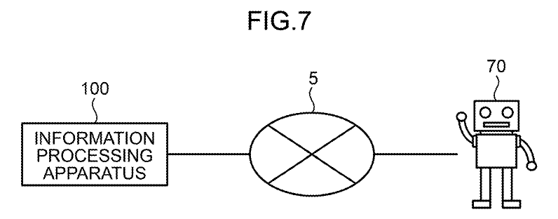

An example of a system according to the embodiment will be described next. FIG. 7 is a diagram illustrating the system according to the embodiment. As illustrated in FIG. 7, this system has the robot 70 and the information processing apparatus 100. The robot 70 and the information processing apparatus 100 are connected to each other via a network 5.

The robot 70 is a robot that has a plurality of joints capable of being driven and executes a plurality of tasks by moving the joints on the basis of motion commands received from the information processing apparatus 100. A camera and the sensors that measure the joint angles are set for the robot 70. For example, in the inference phase, the robot 70 transmits the inference target data 142 having, set therein, image data captured by the camera and the values actually measured by the sensors, to the information processing apparatus 100. The robot 70 is an example of a "target".

The information processing apparatus 100 is an apparatus that executes the process in the training phase and the process in the inference phase, described above.

### Example of Configuration of Information Processing Apparatus

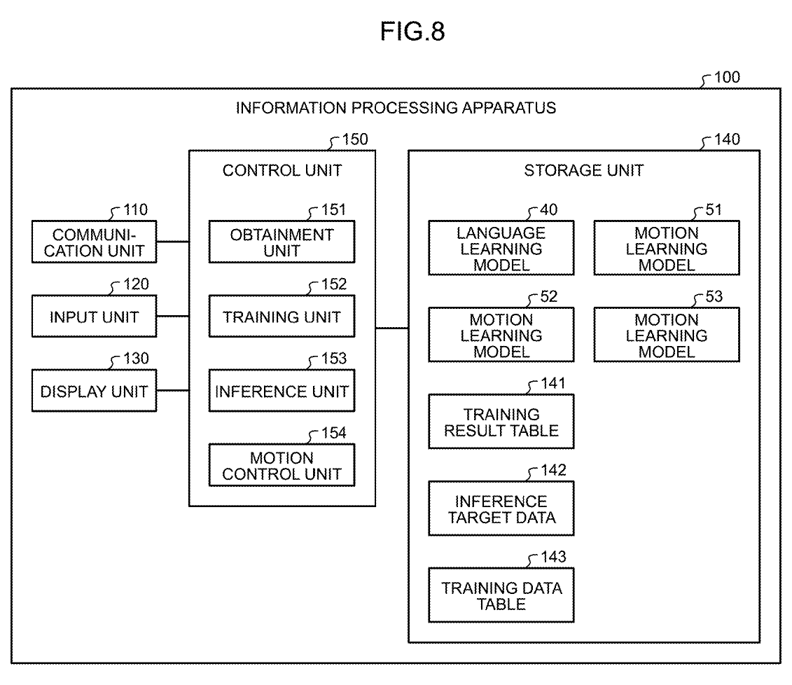

An example of a configuration of the information processing apparatus 100 will be described now. FIG. 8 is a functional block diagram illustrating a configuration of an information processing apparatus according to the embodiment. As illustrated in FIG. 8, the information processing apparatus 100 has a communication unit 110, an input unit 120, a display unit 130, a storage unit 140, and a control unit 150.

The communication unit 110 executes data communication with the robot 70 via the network 5. For example, the communication unit 110 receives the inference target data 142 from the robot 70.

The input unit 120 is an input device that inputs various information to the control unit 150 of the information processing apparatus 100. A user may input motion instruction data by operating the input unit 120. A user may input the initial value of the shared parameter 60 or the initial value of a motion learning model, by operating the input unit 120.

The display unit 130 is a display device that displays information output from the control unit 150.

The storage unit 140 has the language learning model 40, the motion learning models 51 to 53, the training result table 141, the inference target data 142, and a training data table 143. The storage unit 140 is, for example, a memory.

The language learning model 40 is, for example, an LLM. The parameter 40a of the language learning model 40 is a parameter that has been optimized. Other description related to the language learning model 40 is similar to the above description.

The motion learning models 51 to 53 are machine learning models, such as LSTMs. Other description related to the motion learning models 51 to 53 is similar to the above description.

The training result table 141 is generated by the process in the training phase. For example, the training result table 141 has the item numbers, the shared parameters, the parameters, and the identification information. Other description related to the training result table 141 is similar to the description related to FIG. 3, for example.

The inference target data 142 are data transmitted from the robot 70 and include joint angles of the robot in an inference target environment and image data of the robot. Other description related to the inference target data 142 is similar to the above description.

The training data table 143 has training data sets for training the motion learning models 51 to 53. For example, the training data table 143 has the training data sets 71a to 73c. Other description related to the training data sets 71a to 73c are similar to the description related to FIG. 2, for example.

The control unit 150 has an obtainment unit 151, a training unit 152, an inference unit 153, and a motion control unit 154. The control unit 150 is, for example, a central processing unit (CPU) or a graphics processing unit (GPU).

The obtainment unit 151 obtains various data and causes the storage unit 140 to store the data obtained. For example, in the training phase, the obtainment unit 151 obtains the initial value of the shared parameter 60 and the initial values of the parameters of the motion learning models 51 to 53, from the input unit 120. The initial value of the shared parameter 60 and the initial values of the parameters of the motion learning models 51 to 53 may be stored in the storage unit 140 beforehand.

The obtainment unit 151 obtains the inference target data 142 from the communication unit 110 in the inference phase. The obtainment unit 151 obtains motion instruction data in the training phase and the inference phase. The motion instruction data may be stored in the storage unit 140 beforehand.

The training unit 152 executes the process in the training phase. For example, the training unit 152 connects the shared parameter 60 to the intermediate layers of the language learning model 40 and motion learning model 51 to 53. In a state where the parameter 40a of the language learning model 40 has been fixed, the training unit 152 optimizes the shared parameter 60 by backpropagation utilizing motion instruction data. Furthermore, the training unit 152 reads the training data sets 71a to 73c in the training data table 143 and optimizes the parameters of the motion learning models 51 to 53 and the shared parameter 60 by backpropagation. The training unit 152 registers results of the training into the training result table 141.

Other description of the training phase executed by the training unit 152 is similar to the description of the process in the training phase in FIG. 1 to FIG. 3.

The inference unit 153 executes the process in the inference phase. For example, on the basis of the training result table 141, the inference unit 153 sets the parameters of the motion learning models 51 to 53. The inference unit 153 connects the shared parameter 60 to the intermediate layers of the language learning model 40 and motion learning model 51 to 53. The inference unit 153 sets the shared parameter 60 to its initial value. In a state where the parameter 40a of the language learning model 40 and the parameters 51a to 53a of the motion learning models 51 to 53 have been fixed, the inference unit 153 utilizes the inference target data 142 to execute light training by backpropagation and thereby obtains the reference parameter 61.

On the basis of the reference parameter 61 and each of the shared parameters in the training result table 141, the inference unit 153 selects a motion learning model suitable for inference using the inference target data 142. The inference unit 153 infers second state data 21b by inputting inference target data 142 (first state data 21a) to the motion learning model selected. The inference unit 153 outputs the second state data 21b as a motion command, to the motion control unit 154.

Other processing in the inference phase executed by the inference unit 153 is similar to the above described processing in the inference phase in FIG. 4 to FIG. 6.

The motion control unit 154 controls motion of the robot 70 by transmitting the motion command inferred by the inference unit 153, to the robot 70.

### Processing Procedure

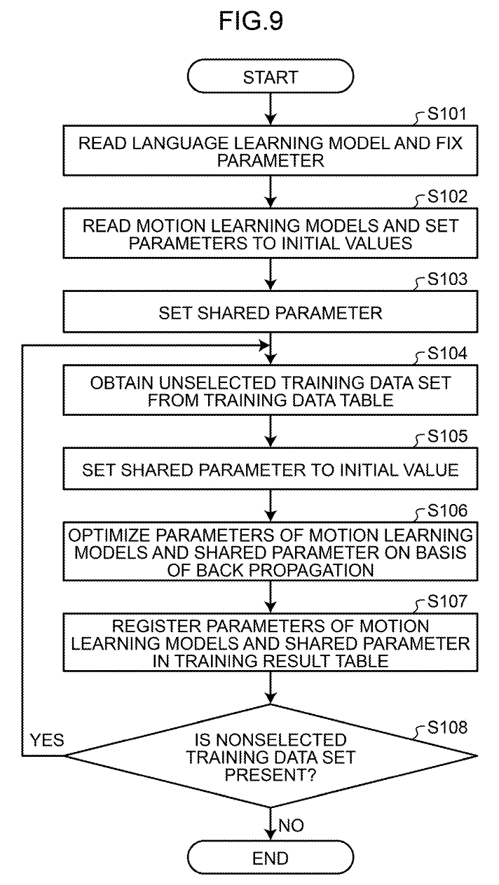

An example of a procedure of processing by the information processing apparatus 100 according to the embodiment will be described next. FIG. 9 is a flowchart illustrating a procedure of the process in the training phase by the information processing apparatus according to the embodiment. As illustrated in FIG. 9, the training unit 152 of the information processing apparatus 100 reads the language learning model 40 and fixes the parameter 40a (Step S101).

The training unit 152 reads the motion learning models 51 to 53 and sets the parameters 51a to 53a to their initial values (Step S102). The training unit 152 sets the shared parameter 60 (Step S103).

The training unit 152 obtains a training data set that has not been selected yet from the training data table 143 (Step S104). The training unit 152 sets the shared parameter 60 to its initial value (Step S105). On the basis of backpropagation, the training unit 152 optimizes the parameters of the motion learning models and the shared parameter (Step S106).

The training unit 152 registers the parameters of the motion learning models and the shared parameter, into the training result table 141 (Step S107). In a case where a training data set that has not been selected yet is present (Step S108, Yes), the training unit 152 proceeds to Step S104.

On the contrary, in a case where a training data set that has not been selected yet is not present (Step S108, No), the training unit 152 ends the process in the training phase.

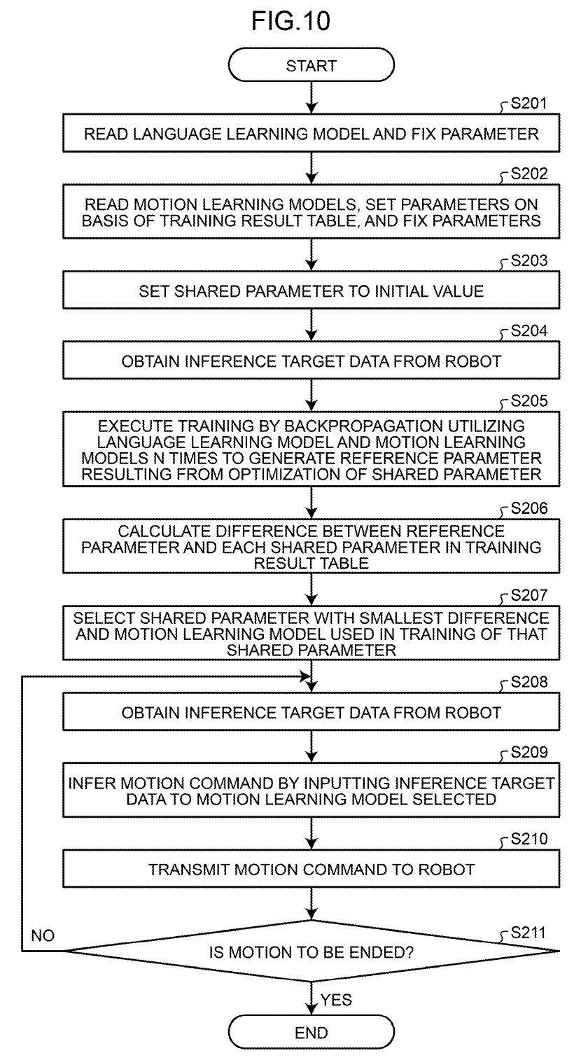

FIG. 10 is a flowchart illustrating a procedure of the process in the inference phase by the information processing apparatus according to the embodiment. As illustrated in FIG. 10, the inference unit 153 of the information processing apparatus 100 reads the language learning model 40 and fixes the parameter 40a (Step S201).

The inference unit 153 reads the motion learning models 51 to 53, sets the parameters 51a to 53a on the basis of the training result table 141, and fixes these parameters 51a to 53a (Step S202). The inference unit 153 sets the shared parameter to its initial value (Step S203).

The obtainment unit 151 of the information processing apparatus 100 obtains inference target data 142 from the robot 70 (Step S204). The inference unit 153 executes training using backpropagation by utilizing the language learning model and the motion learning models N times and generates the reference parameter 61 resulting from optimization of the shared parameter 60 (Step S205).

The inference unit 153 calculates a difference (distance) between the reference parameter 61 and each of the shared parameters in the training result table 141 (Step S206). The inference unit 153 selects the shared parameter with the smallest difference and the motion learning model used in the training of that shared parameter (Step S207).

The obtainment unit 151 obtains inference target data 142 from the robot 70 (Step S208). By inputting the inference target data 142 into the motion learning model selected, the inference unit 153 infers a motion command (Step S209).

The motion control unit 154 of the information processing apparatus 100 transmits the motion command to the robot 70 (Step S210). In a case where the motion is not to be ended (Step S211, No), the information processing apparatus 100 proceeds to Step S208. On the contrary, in a case where the motion is to be ended (Step S211, Yes), the information processing apparatus 100 ends the process in the inference phase.

### Effects

Effects of the information processing apparatus 100 according to the embodiment will be described next. For example, from results in the training phase, the information processing apparatus 100 stores the optimal values of the shared parameter 60 added to the motion learning models and language learning model and the optimal values of the parameters of the motion learning models. In the inference phase, by using data obtained from the robot 70 in a real environment, the information processing apparatus 100 performs optimization of the initialized shared parameter several times to generate the optimized reference parameter 61, selects the optimal motion learning model on the basis of each of the shared parameters 60 in the training phase and the reference parameter 61, and utilizes the selected optimal motion learning model in inference. Reduction in the prediction performance of the machine learning model is thereby able to be minimized and the computational cost of the machine learning model is able to be reduced.

More specifically, in the training phase, the information processing apparatus 100 adds the shared parameter 60 to the parameters 51a to 53a of the motion learning models 51 to 53 and the parameter 40a of the language learning model 40. By using training data sets, the information processing apparatus 100 optimizes the parameters of the motion learning models and the shared parameter 60 through training corresponding to the training data sets. Furthermore, through training using motion instruction data, the information processing apparatus 100 optimizes the shared parameter 60 in a state where the parameter 40a of the language learning model 40 has been fixed. Every time the information processing apparatus 100 performs training for each training data set, the information processing apparatus 100 registers the optimized parameter of the motion learning model and the shared parameter 60 into the training result table 141 in association with each other.

In the inference phase, the information processing apparatus 100 adds the shared parameter 60 to the parameters 51a to 53a of the motion learning models 51 to 53 and the parameter 40a of the language learning model 40. The information processing apparatus 100 obtains inference target data from the robot 70, and generates the reference parameter 61 resulting from optimization of the shared parameter 60 on the basis of the inference target data, in a state where the optimized parameters of the language learning model and motion learning models have been fixed. The information processing apparatus 100 selects a motion learning model from the motion learning models 51 to 53 on the basis of a plurality of shared parameters obtained from the motion learning models 51 to 53 through prior training and the reference parameter 61, and infers a second state by inputting a first state in the inference target data to the motion learning model selected.

As described above, reduction in the prediction performance of the machine learning model is able to be minimized and the computational cost of the machine learning model is able to be reduced by the information processing apparatus 100 executing the training phase and the inference phase.

In the example described with respect to the embodiment, the robot 70 and the information processing apparatus 100 are connected via the network 5, but the embodiment is not to be limited to this example. For example, functions of the information processing apparatus 100 may be configured to be incorporated into the robot 70.

### Hardware Configuration

An example of a hardware configuration of a computer that implements functions similar to those of the information processing apparatus 100 according to the embodiment described above will be described in sequence next.

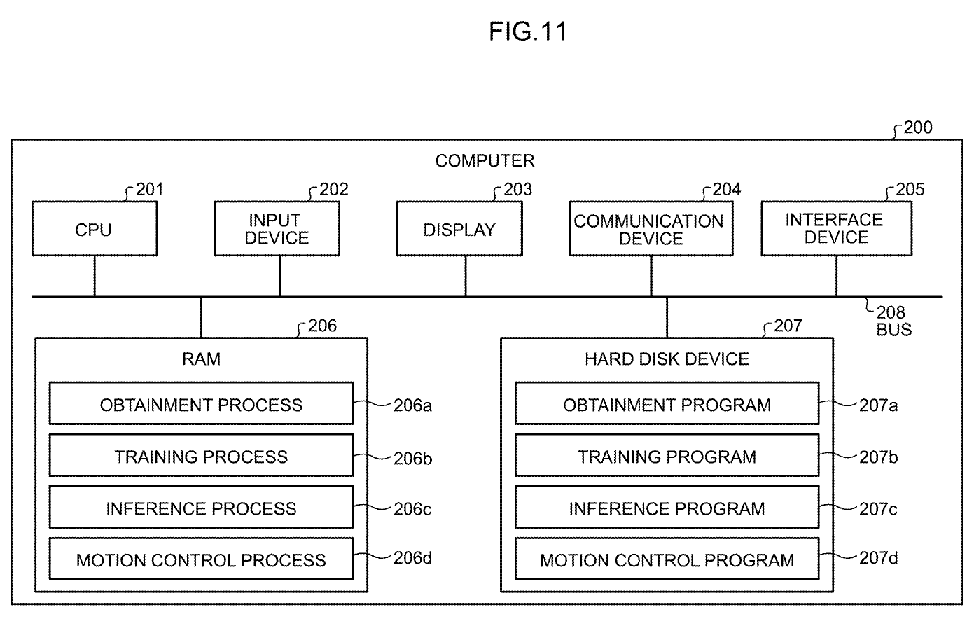

FIG. 11 is a diagram illustrating an example of a hardware configuration of a computer that implements functions similar to those of the information processing apparatus according to the embodiment. As illustrated in

FIG. 11, a computer 200 has a CPU 201 that executes various arithmetic processing, an input device 202 that receives input of data from a user, and a display 203. Furthermore, the computer 200 has a communication device 204 that transmits and receives data to and from the robot 70 via a wired or wireless network, and an interface device 205. The computer 200 also has a RAM 206 that temporarily stores various information, and a hard disk device 207. Each of these devices 201 to 207 is connected to a bus 208.

The hard disk device 207 has an obtainment program 207a, a training program 207b, an inference program 207c, and a motion control program 207d. The CPU 201 reads the programs 207a to 207d and loads the read programs 207a to 207d into the RAM 206.

The obtainment program 207a functions as an obtainment process 206a. The training program 207b functions as a training process 206b. The inference program 207c functions as an inference process 206c. The motion control program 207d functions as a motion control process 206d.

Processing in the obtainment process 206a corresponds to the processing by the obtainment unit 151. Processing in the training process 206b corresponds to the processing by the training unit 152. Processing in the inference process 206c corresponds to the processing by the inference unit 153. Processing in the motion control process 206d corresponds to the processing by the motion control unit 154.

The programs 207a to 207d may be not stored in the hard disk device 207 from the beginning. For example, each program is stored in a "portable physical medium", such as a flexible disk (FD), a CD-ROM, a DVD, a magneto-optical disk, or an IC card, which is to be inserted in the computer 200. The computer 200 may then read and execute the programs 207a to 207d therefrom.

Reduction in the prediction performance of a machine learning model is able to be minimized and the computational cost of the machine learning model is able to be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has(have) been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
adding a shared parameter to: parameters of a plurality of motion learning models that each predict a second state of a target from a first state of the target; and a parameter of a language learning model that has been trained, the language learning model being related to a motion instruction for the target;
obtaining a training data set including a plurality of sets of training data each having the first state as input data and the second state as ground truth data; and
optimizing, by using the training data set, the shared parameter and a parameter of a motion learning model of the plurality of motion learning models, the motion learning model corresponding to the training data set, in a state where the parameter of the language learning model has been fixed.

2. The non-transitory computer-readable recording medium according to claim 1, wherein the process further includes: obtaining a motion instruction; and optimizing the shared parameter, so that output upon input of the motion instruction to the language learning model is a result obtained by reconstruction of the motion instruction.

3. The non-transitory computer-readable recording medium according to claim 2, wherein the process further includes registering the parameter of the motion learning model and the shared parameter into a storage in association with each other, after the optimizing.

4. A non-transitory computer-readable recording medium having stored therein a program that causes a computer to execute a process comprising:
adding a shared parameter to: parameters of a plurality of motion learning models that each predict a second state of a target from a first state of the target; and a parameter of a language learning model that has been trained, the language learning model being related to a motion instruction for the target;
obtaining inference target data including the first state and the second state from the target;
generating a reference parameter resulting from optimization of the shared parameter based on the inference target data, in a state where optimized parameters of the language learning model and motion learning models have been fixed;
selecting a motion learning model from the plurality of motion learning models based on the reference parameter and a plurality of shared parameters obtained from the plurality of motion learning models by prior training; and
inferring a second state by inputting a first state in the inference target data to the motion learning model selected.

5. The non-transitory computer-readable recording medium according to claim 4, wherein the process further includes obtaining a motion instruction related to the inference target data; and generating the reference parameter by optimizing the shared parameter, so that output upon input of the motion instruction to the language learning model is a result obtained by reconstruction of the motion instruction.

6. A training method comprising:
adding a shared parameter to: parameters of a plurality of motion learning models that each predict a second state of a target from a first state of the target; and a parameter of a language learning model that has been trained, the language learning model being related to a motion instruction for the target;
obtaining a training data set including a plurality of sets of training data each having the first state as input data and the second state as ground truth data; and
optimizing, by using the training data set, the shared parameter and a parameter of a motion learning model of the plurality of motion learning models, the motion learning model corresponding to the training data set, in a state where the parameter of the language learning model has been fixed, by using a processor.

7. The training method according to claim 6, further including: obtaining a motion instruction; and optimizing the shared parameter, so that output upon input of the motion instruction to the language learning model is a result obtained by reconstruction of the motion instruction.

8. The training method according to claim 7, further including registering the parameter of the motion learning model and the shared parameter into a storage in association with each other, after the optimizing.

9. An inference method comprising:
adding a shared parameter to: parameters of a plurality of motion learning models that each predict a second state of a target from a first state of the target; and a parameter of a language learning model that has been trained, the language learning model being related to a motion instruction for the target;
obtaining inference target data including the first state and the second state from the target;
generating a reference parameter resulting from optimization of the shared parameter based on the inference target data, in a state where optimized parameters of the language learning model and motion learning models have been fixed;
selecting a motion learning model from the plurality of motion learning models based on the reference parameter and a plurality of shared parameters obtained from the plurality of motion learning models by prior training; and
inferring a second state by inputting a first state in the inference target data to the motion learning model selected, by using a processor.

10. The inference method according to claim 9, further including obtaining a motion instruction related to the inference target data; and generating the reference parameter by optimizing the shared parameter, so that output upon input of the motion instruction to the language learning model is a result obtained by reconstruction of the motion instruction.

11. An information processing apparatus comprising:
a memory; and
a processor coupled to the memory and configured to:
add a shared parameter to: parameters of a plurality of motion learning models that each predict a second state of a target from a first state of the target; and a parameter of a language learning model that has been trained, the language learning model being related to a motion instruction for the target;
obtain a training data set including a plurality of sets of training data each having the first state as input data and the second state as ground truth data; and
optimize, by using the training data set, the shared parameter and a parameter of a motion learning model of the plurality of motion learning models, the motion learning model corresponding to the training data set, in a state where the parameter of the language learning model has been fixed.

12. The information processing apparatus according to claim 11, wherein the processor is further configured to: obtain a motion instruction; and optimize the shared parameter so that output upon input of the motion instruction to the language learning model is a result obtained by reconstruction of the motion instruction.

13. The information processing apparatus according to claim 12, wherein the processor is further configured to: register the parameter of the motion learning model and the shared parameter into a storage in association with each other, after the optimizing.

14. An information processing apparatus comprising:
a memory; and
a processor coupled to the memory and configured to:
add a shared parameter to: parameters of a plurality of motion learning models that each predict a second state of a target from a first state of the target; and a parameter of a language learning model that has been trained, the language learning model being related to a motion instruction for the target;
obtain inference target data including the first state and the second state from the target;
generate a reference parameter resulting from optimization of the shared parameter based on the inference target data, in a state where optimized parameters of the language learning model and motion learning models have been fixed;
select a motion learning model from the plurality of motion learning models based on the reference parameter and a plurality of shared parameters obtained from the plurality of motion learning models by prior training; and
infer a second state by inputting a first state in the inference target data to the motion learning model selected.

15. The information processing apparatus according to claim 14, wherein the processor is further configured to: obtain a motion instruction related to the inference target data; and generate the reference parameter by optimizing the shared parameter, so that output upon input of the motion instruction to the language learning model is a result obtained by reconstruction of the motion instruction.
